(19) United States
(12) Patent Application Publication
(10) Pub. No.: US 2007/0107282 A1
(43) Pub. Date: May 17, 2007

(54) Advertising device

(76) Inventor: Emil Kirov Pramatarov, Tsarevo (BG)

Correspondence Address: Mr. Nikolay Radoslavov, 128, 8-th Primorski Polk, Blvd, Varna Breeze Patent Ltd., Varna, 9002, BG

(21) Appl. No.: 10/580,010

(22) PCT Filed: Dec. 23, 2003
(86) PCT No.: PCT/BG03/00045

§ 371 Date: May 19, 2006

(30) Foreign Application Priority Data
Nov. 26, 2003 (BG) 108386

(51) Int. Cl. G09F 11/02

(52) U.S. Cl. 40/493

(57) ABSTRACT

The invention relates to an advertising device, which can be implemented in the field of advertising through exposing on public places of big format full colour images (as posters, billboards etc) of goods and/or services being advertised. The device is formed as a vertical regular n-angular prism, n being freely optional number, rotating around its longitudinal axis of symmetry and a possibility is also provided for mounting the whole device on a lorry platform. The vertical rectangular walls of the prism are performed as observing windows (1.1, 1.2, . . . 1.n) whereon can be watched the consecutive appearance of independent images, printed on a flexible tape. The advertising device is carried out as a set of several kinematically independent contours (modules) mounted on a common internal frame (6) where the observing windows of the particular modules form the outside visible walls of the device. The device enables a consecutive appearance of the images on the observing window without a necessity of a reversal of the direction of the movement of the tape with the images printed thereon in order to accomplish a full cycle. Thus a complete equality is achieved in term of frequency of appearance within the cycle of the images on the observing windows.

### TECHNICAL FIELD

The invention relates to an advertising device, which can be implemented in the field of advertising through exposing on public places of big format full colour images (as posters, billboards etc) of goods and/or services being advertised.

### BACKGROUND ART

An advertising device is known [1], for a consecutive exposure of images on an observing window. The images are reproduced in a sequence on a flexible tape, the first end of which is fixed to a feeding roll whilst the other end is fixed to an accepting roll. The distance between the roll axes is relevant to the visible height of the single image. The rolls are driven by means of an electric motor where the tape is being rolled from the feeding to the accepting roll. In a strictly preset moments the rolls are positioned thus allowing the images to consecutively be exposed on the observing window. After all images of the sequence are exposed the electric motor is reversed, the accepting roll renders feeding and vice versa. Now the images are exposed in an adverse sequence. Then the motor is reversed again and the cycle is endless repeated.

Said device has the disadvantage of an uneven appearance of the images of the sequence due to reversed motion of the rolls. For example, when the sequence contains three images, their appearance will be in an order 1,2,3,2,1,2,3 . . . etc. It is obvious that the frequency of appearance of image No 2 is twice as much as that of images No 1 and No 3. This leads to the necessity different prices to be contracted for each image being advertised due to the non-equivalent advertising effect. A disadvantage is also the impossibility to expose conceptual connected images, consequently developing the advertising idea where the reverse of the sequence is inadmissible.

### SUMMARY OF THE INVENTION

The invention seeks to provide an advertising device which can enable the sequent appearance of the images printed on a durable tape carrier on the observing window, where the possibility of direct observation is provided without the necessity of an additional enlargement or projecting system and where also the appearance of the images to be independent of the reversal of the sequence in a full operating cycle. It is aimed also to enlarge the observing area and the observing angles to be increased up to a full circle as well as to eliminate the necessity of fixing the device to a constant place thus decreasing the number of the consumers of the advertising effect.

In accordance with the invention, this object is accomplished in an advertising device having a form of a vertical regular n-angular prism, n being freely optional number, rotating around its longitudinal axis of symmetry by means of electric motors where a possibility is also provided for mounting the whole device on a lorry platform. The vertical rectangular walls of the prism are performed as observing windows whereon can be watched the consecutive appearance of independent images, printed on a flexible tape. The both ends of the tape are fixed so as to enable a contact between the first and last image of the sequence thus providing the consecutive exposure of the images on the observing windows without a necessity of a reversal of the order of their appearance.

Each of the tapes bearing the images is lengthwise double-sided fixed to spiral springs, spaced apart from one another and working under tension. The ends of the springs are formed as hooks, attached to openings spaced apart from one another double-sided lengthwise of the tape, said openings being strengthened by means of pressed metal rings, while the opposite ends of springs are attached to plates provided with openings. The opposite sides of said plates are attached by means of spot welds to the outer sides of the outer links of a standard gearing chain in the zone between the axes of the rolls. Said plates are spaced apart from one another lengthwise of the chain at a distance of an even number of links. To the opposite sides of the chain links by means of spot welds are attached another plates where each plate bears a module of two rolling bearings mounted to a common axis whilst the plate itself is placed between the bearings. The bearings are rolling in hollow rectangular profiles elaborated of metal sheets, said profiles being provided with longitudinal slots enabling the plates supporting the bearings to freely move whilst the chain remains out of the profile. The profiles are fixed by means of bolts to a rigid supporting frame which forms the internal structure of the device. Vertically and parallel to the longitudinal axis of symmetry of the prism are mounted rolls each of them consisting of a longitudinal axis and a hollow shaft mounted double-sided thereon by means of bearings as well as two chain gears mounted on said axis by means of bearings. The chain gears are arranged symmetrically about the both ends of the hollow shaft at distances relevant to the lengths of the spiral springs carrying the tape in operating mode. Each of the tapes in the independent contours (modules) forming the device is provided with two rolls arranged on the left and right sides out of the visible area of the observing window, the distance between the axes being chosen to be in excess of the length of the single image so that this section of the tape to be evenly strained. The rest of the full length of the tape is compensated by other rolls arranged inside the structure of the relevant module wherein the tape consecutively contacts bilaterally with their cylindrical surfaces thus forming a closed curved contour. For at least one of the rolls in each module a possibility is provided said roll to be moved parallel to its own axis which is realized by means of a hinge connection with the supporting frame thus enabling synchronous tightening of both chains, respectively of the tape: Another of the rolls in the module is intended to driving and positioning of the chains and the tape. The axes of these rolls are mounted on the rigid frame by means of bearings whilst the chain gears are fixed to the axes whereto also an additional gear wheel or belted wheel is attached coupled to an electric motor intended for driving and positioning of the chains and the tape. Thus are created two independent sets each of them consisting of two chains forming symmetrical closed curved contours synchronously driven and positioned by means of electric motors, monitoring devices and electronic control devices performing the turning in/off and the reversing of the electric motors when necessary according to exactly preset programs. The tapes with the images printed thereon remain evenly tightened between both chains due to the springs mounted double-sided lengthwise of the tape and effecting the tightening upon the vertical rolls. The outside circle diameter of the chain gears equals to the outside diameter of the hollow shafts of the rolls whilst the length of the chains is equal to the length of the tape with the images printed thereon. Due to the fact that the hollow shafts are freely rolling on the axes and the tapes are moving only due to their attachment by means of springs to the chains which on their part are moving synchronously in pairs, lengthwise of the closed contours which results in the easy even movement of the tapes while the springs have also the additional function to damp the inertial forces arisen at starting/stopping.

In its entirety the advertising device is carried out as a set of several kinematically independent contours (modules) mounted on a common internal frame where the observing windows of the particular modules form the outside visible walls of the device while a possibility is also provided said walls to be protected of the atmospheric influence by means of dismountable transparent screens of a glass or polymer. The upper and the lower horizontal bases as well as the vertical outside edges of the device are covered by metal sheets or similar kind of sheet material resistant to the atmospheric influence. Thus the internal structure of the device is hermetically closed which results in a protection of the driving elements of a dust and corrosion as well as it contributes the aesthetic appearance of the device. Behind the visible useful surface of tape positioned in the observing windows are arranged electrical illuminants providing an even light stream part of which penetrates through the tape material with the images printed thereon thus enabling the images to be observed also during the night. Lengthwise of the vertical axis of symmetry of the entire device leads a hollow shaft rigidly fixed to the internal structure of the supporting frame, said hollow shaft being double-sided mounted by means of bearings on an axis the lower end of which is rigidly fixed to the foundation plate. Coaxially to the shaft is fixed a gear wheel or a belted wheel enabling a coupling to an electric motor rotating the whole device around its vertical axis of symmetry. Thus a possibility is provided the observing windows to evenly be exposed at all possible angles until a full circle.

Through mounting of the device upon a lorry platform a possibility is provided the device to be transported to any wished place as well as the device to be used under transportation.

The advertising device in accordance with the invention has a number of advantages, as follows:
A possibility is realized for a consecutive appearance of the images on the observing window without a necessity of a reversal of the direction of the movement of the tape with the images printed thereon in order to accomplish a full cycle. Thus a complete equality is achieved in term of frequency of appearance within the cycle of the images on the observing windows;
A possibility is realized for a consecutive representation of interconnected images representing an advertising idea;
In the event of a failure to renew a contract for anyone of the images of the sequence already printed on the tape the operation can be carried out with the rest two images without a necessity of a dismantling and rearrangement of the images on the tape;
Due to the fact that the tapes are lengthwise double-sided elastically fixed to the synchronously driven chains providing the possibility for an even transportation of the parallel parts of the tape, there is no need of mounting of complex monitoring devices for permanent adjustment of the angle between the axes of the feeding and the accepting rolls what the technical solution belonging to the background art is aiming to ensure the even reeling of the tape upon the accepting roll;
Due to the forming of the device as a set of several independent contours of tapes bearing the images, each contour having a separate observing window an enlargement of the useful surface is achieved as well as an increase of the general number of the images shown;
Due to the rotating of the whole device around its vertical axis of symmetry a possibility is provided for an equal exposure at all possible observing angles, including a full circle observation, for anyone of the observing windows;
The mounting of the device upon the lorry platform enables the advertising to be performed at any freely chosen place as well as under transportation.

### DESCRIPTION OF THE FIGURES IN THE DRAWINGS

The invention will now be described by way of examples and with reference to the accompanying in which:

FIG. 1 is a perspective view of a variant embodiment of the advertising device in accordance with the invention, formed as a regular triangle prism mounted on the platform of a lorry;

FIG. 2 is a top view of the kinematic coupling scheme of the upper and lower driving chains for one of the independent contours;

FIG. 3 is a front view accompanied by a partial cross sectional view at the upper end of one of the outside leading rolls showing a part of the chain and the fixing thereto by means of springs and plates of the tape-carrier;

FIG. 4 illustrates the arrangements of the mechanisms on the driving roll;

FIG. 5 is A-A cross-sectional view of the one of the links of the driving chain with the plates mounted thereon;

FIG. 6 is top view of the kinematic coupling scheme of the upper of the both driving chains in a variant embodiment where the device is formed as a regular rectangular prism;

FIG. 7 is a top view of the kinematic coupling scheme of the upper of the both driving chains in a variant embodiment of the device having two vertical observation planes with back to back arrangement.

### DETAILED DESCRIPTION OF THE EMBODIMENTS

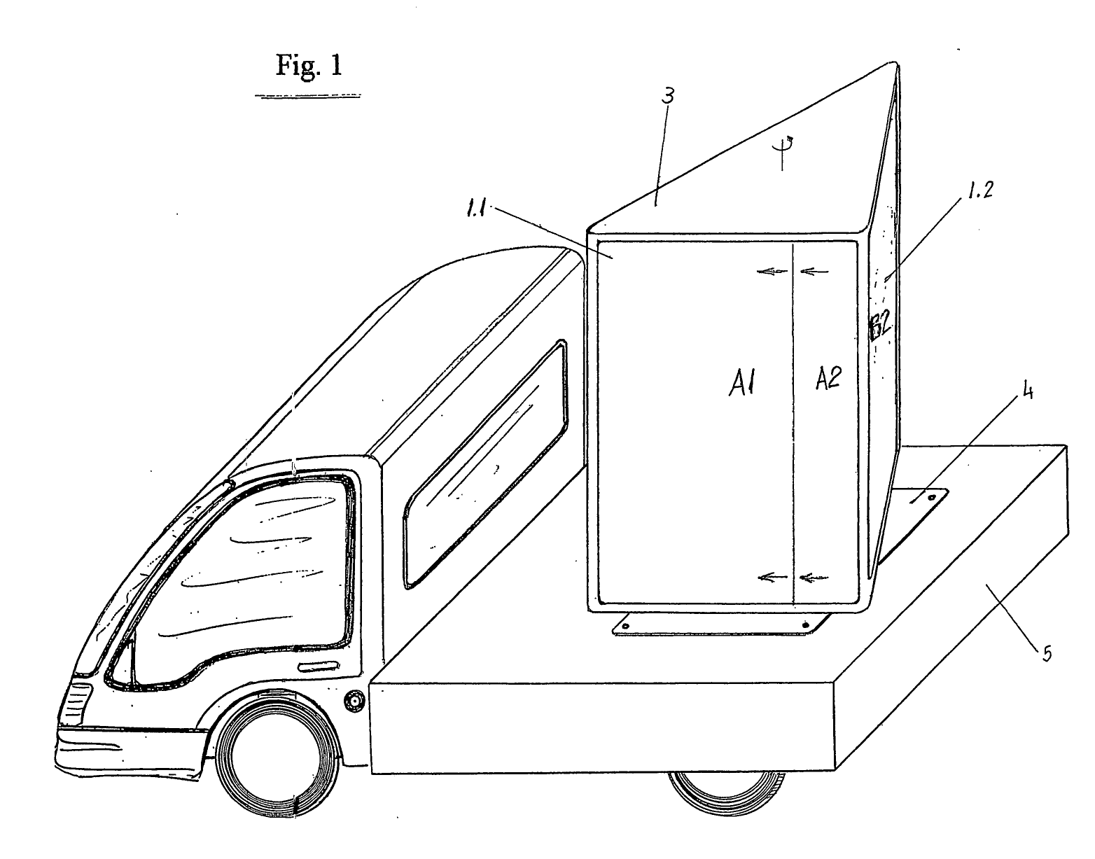

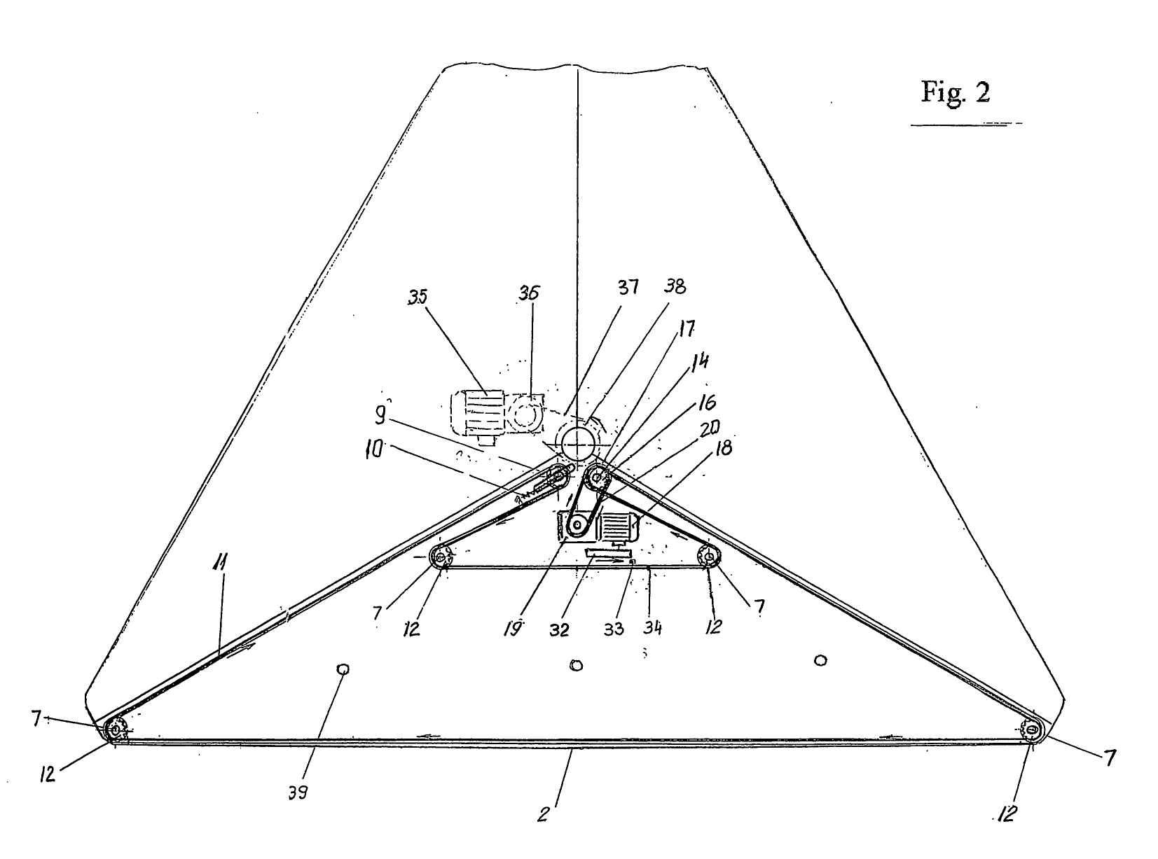

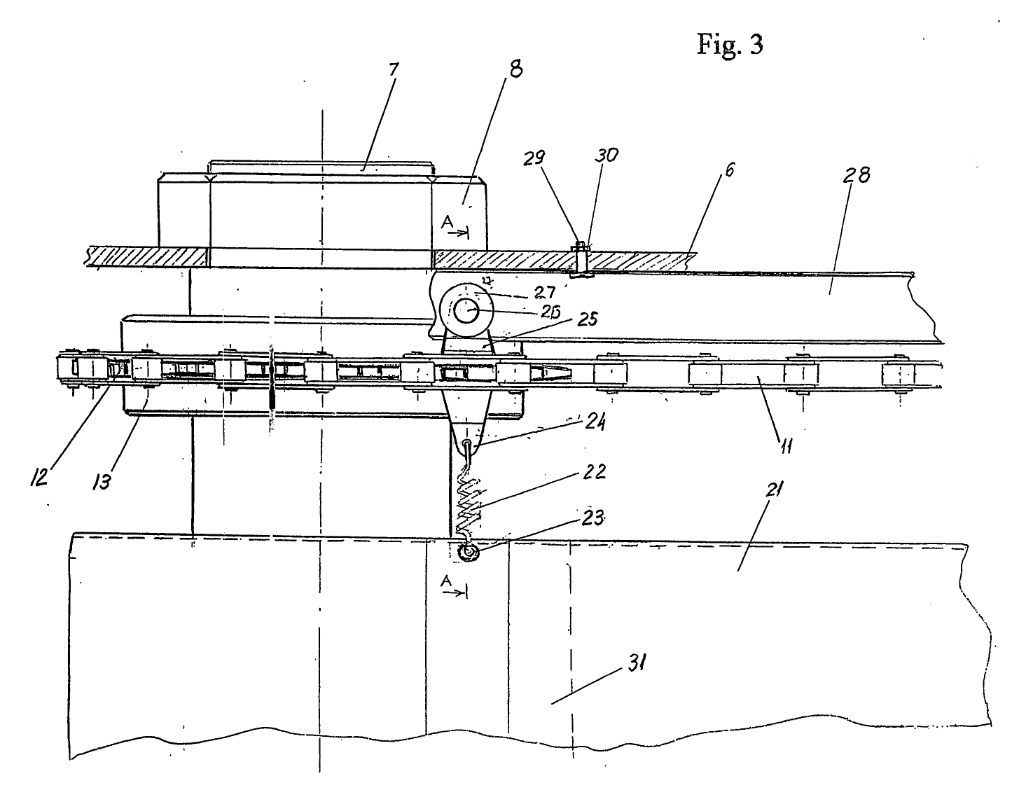

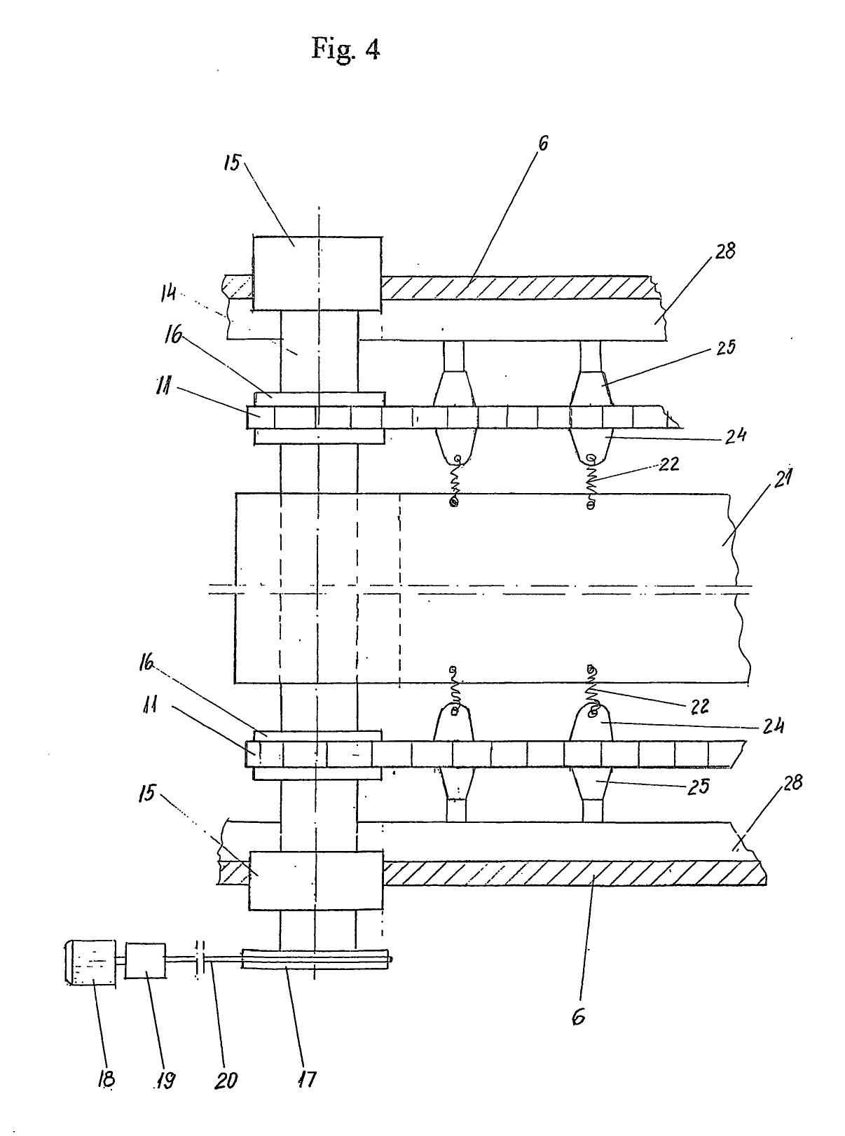

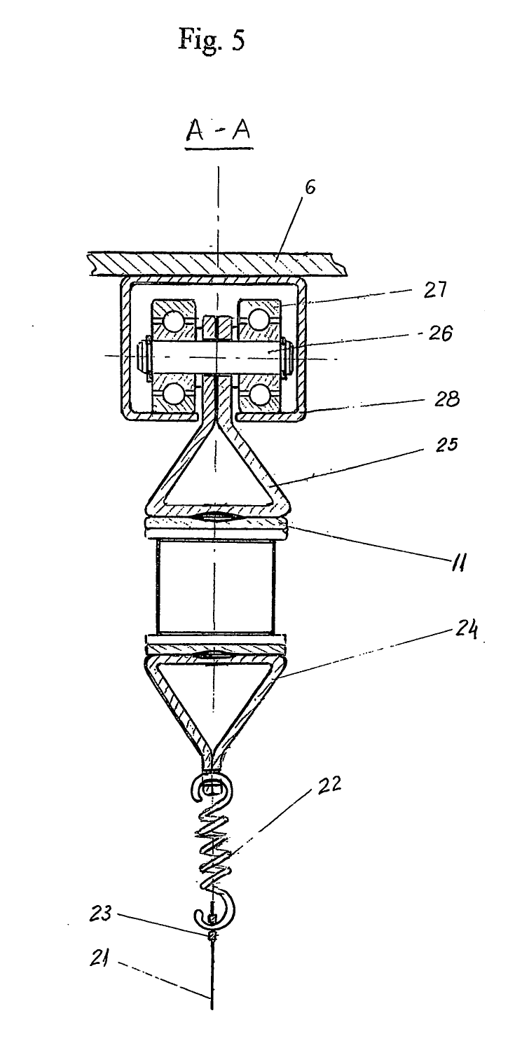

In accordance with the examples shown one preferable embodiment of the invention is shown in FIGS. 1, 2, 3, 4 and 5. The advertising device represents a regular triangle prism wherein the outside vertical rectangular walls are formed as observing windows 1.1, 1.2, 1.3, wherein can be observed the consecutive appearance and positioning in the visible area of each of the windows of a sequence of three separate images A.1, A.2, A.3, B.1, B.2, B.3, C.1, C.2 and C.3 each of them bearing a concrete advertising message. FIG. 1 illustrates the change in an observing window 1.1 of an image A.1 by image A.2 while in an observing window 1.2 is shown an image B.2 already positioned. The windows 1.1, 1.2, 1.3 are protected of the atmospheric influence by means of screens 2 made of a transparent plastic material, for example plexyglas. The rest outside surfaces of the prism form the shell 3 made of stainless metal sheets. The device is mounted by means of bearings about its vertical axis of symmetry on the foundation 4 while said foundation 4 is rigidly fixed to the platform 5 of a lorry. The internal supporting frame 6 of the device represents a spatial welded structure of a bar steel, whereto by means of the fixing nuts are rigidly fixed the axes of rolls 7. The rolls are arranged vertically parallel each to other as shown in FIG. 2. The axes of rolls 9 on their part can be moved where they are sliding upon the slots (not shown in the figures) specially cut in the frame 6 whilst said rolls 9 remain parallel to rolls 7 and 14. This is achieved by means of the spring 10 effecting a force on the both ends of the axis of a roll 9. Thus is achieved the necessary strain of the chains 11 coupled to the chain gears 12 mounted by means of bearing assemblies 13 on the axes of rolls 7 and 9. The axes of rolls 14 are mounted on the frame 6 in their both ends by means of bearing assemblies 15 fixed rigidly to the frame 6. Also rigidly to the axes of rolls 14 are coaxially fixed chain gears 16 whereto are coupled the chains 11. To the axes of rolls 14 are also rigidly and coaxially fixed belted wheels 17 providing the driving moment of the electric motors 18 through reducers 19 and belts 20 to be transmitted to the chains 11 synchronized by gear wheels 16. The full length of the chains 11 is equal to the sum of the breaths of the three images in each module i.e. it is identical to the full perimeter of the closed curved contour which are following the tapes 21 bearing the images. On their part the tapes 21 are elaborated of a lasting fabric covered bilaterally by a layer of a polyvynilchloride, on the front side of said tapes 21 being printed the advertising messages. Lengthwise of the tape, bilaterally are spaced apart from one another the openings 23 strengthened by means of pressed metal rings. To the openings 23 are attached springs 22 which opposite ends are formed as hooks and are attached to the plates 24 provided with openings. The opposite sides the plates 24 are attached by means of spot welds to the outer sides of the outer links of a standard gearing chains 11 in the zone between the axes of the rolls. The plates are spaced apart from one another lengthwise of the chain 11 at a distance of an even number of links as shown in FIGS. 3 and 4. To the opposite sides of the chain links by means of spot welds are attached steel plates 25 provided with openings wherein are fixed the axes 26. To each of said axes 26 from the both sides of plates 25 are rigidly attached two rolling bearings 27. The bearings 27 are rolling longitudinally inside the hollow rectangular profiles 29 made of metal sheets whilst the profiles are provided with longitudinal slots enabling the plates 25 supporting the bearings 27 to freely move whilst the chain 11 remains outside of the profile. The profiles 28 are rigidly fixed to the rigid supporting frame 6 by means of bolts 29 and nuts 30 so that the chains 11 to be supported while the axis of symmetry of the cross section of profiles 28 exactly follows the closed contour done by the chains 11, respectively the cross parallel parts of tapes 21 when moving in the horizontal plane. On each of axes 7, 9, 14 are mounted double-sided by means of bearings hollow shafts 31 elaborated of polished hollow bars of stainless steel—their total number is 18 for the whole device. The hollow shafts 31 are supporting the tapes 21 strained at the straight line parts of the contours when driven by chains 11 through springs 23 thus the images being changed in the observing windows 1.1, 1.2, 1.3 when performing the operating cycles. For the independent in accordance with a preset program, transportation and positioning of the tapes 21, a program control-supply block 32 is provided, said block 32 turning in the power supply of the electric motor 18 and the tape 21 is moved until the relay 33 receives a command to turn off one of the three, for each of the three separate contours, fingers 34 spaced apart from one another lengthwise of the lower chain 11 taking into consideration the necessary advance so that the positioning of the tapes to be realized in way enabling the centering, respectively the representation of the images in the observing windows 1.1, 1.2, 1.3. After a stay of the electric motor in turn off position for a strictly preset, by means of time-relay, period of time, during which the advertising message is realized, the electric motor 18 is again turned in, the tape 21 being moved and positioned to the next image of the sequence etc. The rotation of the whole device around its vertical axis of symmetry is performed by the electric motor with reducer 35 and belt transmission, consisting of a wheel 36 coupled to the output shaft of the reducer 35, a belt 37 and a wheel 38, rigidly attached to the frame 6, coaxially to the vertical axis of symmetry of the device, said wheel 38 being arranged in the zone of the lower end, close to the foundation 4. The frame 6 on its part is mounted at both the upper and the lower end by means of bearings coaxially to its vertical axis of symmetry on a steel axis, said axis being rigidly fixed to foundation 4. In order to reduce the stresses arisen at the fixing point during the transportation on the lorry platform 5, due to the shake and the wind forces, under the lower triangle base of the device, respectively close to each of the angles are mounted three subsidiary rolls acting as an additional support, said rolls freely rolling on the platform 5 of the lorry. Behind the visible useful field tapes 21 bearing the images are arranged electrical illuminants 39 providing an even light stream part of which penetrates through the partially translucent material of the tapes with the images printed thereon thus enabling the images to be observed on the observing windows 1.1, 1.2, 1.3 also during the night.

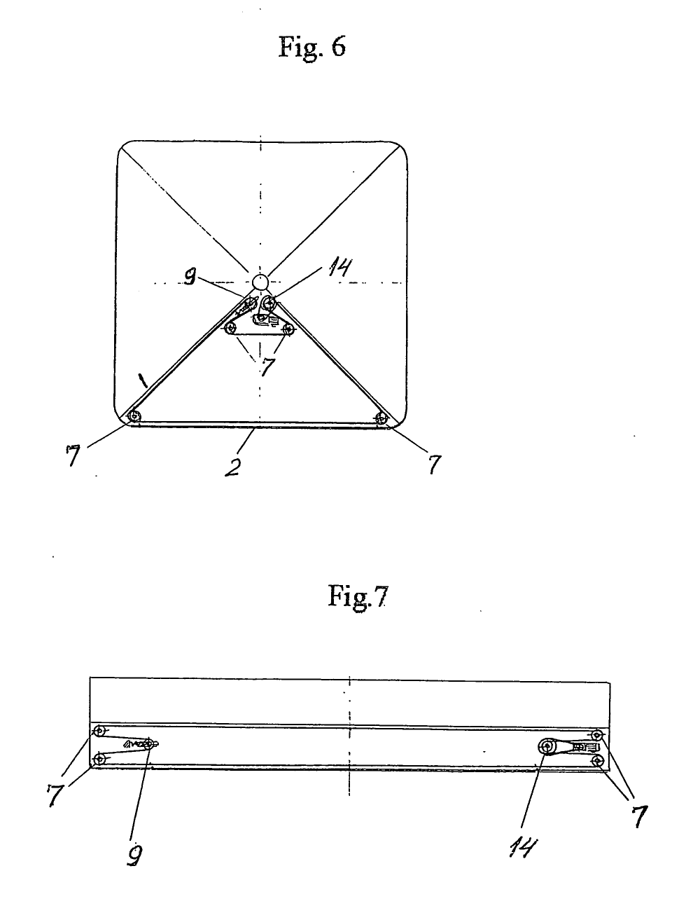

In FIG. 6 is shown a variant embodiment of the advertising device formed as a regular rectangular prism. Said device has four operating walls, respectively four observing windows and four separate driving contours. The kinematic scheme of drive of each contour is the same as described above for the basic variant performed as a triangular prism. A possibility is also provided for a rotation of the device around its vertical axis of symmetry.

In FIG. 7 is shown a variant embodiment of the device having two vertical observing planes with back to back arrangement. The device is provided with two identical driving contours having driving schemes analogous to the already described for the basic variant with a triangle prism. A possibility is also provided for a rotation of the device round its vertical axis of symmetry.

[1]—Patent of France No 7617326, Int. Cl. G09 F 11/24

1. An advertising device, characterised in that it is performed as a regular n-angular prismatic body, comprising observing windows (1.1, 1.2, . . . 1.n), to each observing window, on common supporting frame (6), is formed a separate, kinematically independent contour, comprising a tape (21), rolls (7, 9, 14), arranged parallel to the vertical axis of symmetry of the prismatic body, the axes of rolls (7) being rigidly fixed to the supporting frame (6) by means of nuts (8), whilst the axis of a roll (9) is mounted in a flat slot cut out in the frame (6), said roll (9) having the possibility to be moved upon the frame (6) in a horizontal direction, a roll (14) being mounted by means of bearing assemblies (15) on the frame (6), whilst double-ended to the axes of rolls (7, 9) are fixed bearing assemblies (13) with chain gears (12) attached thereto, whilst to the axis of a roll (14) coaxially are rigidly fixed chain gears (16), to said chain gears (12, 16) being coupled chains (11), to which by means of springs (23) and plates (24) is attached a tape (21), the chains (11) on their part by means of plates (25) and bearings (27) being attached to hollow steel profiles (28), rigidly fixed to the frame (6), the tape (21) itself being formed as a closed contour is put upon hollow shafts (31), which are mounted double-sided by means of bearings on the axes of rolls (7, 9, 14), whilst to the lower end of the axis of a roll (14) coaxially is rigidly fixed a belted wheel (17), coupled by means of a belt (20) and a reducer (19) to an electric motor (18), connected by means of a relay (33) to a control-supply block (32), whilst the common supporting frame (6), on its part, by means of a rigidly fixed hollow shaft thereto is mounted coaxially to the vertical axis of symmetry by means of bearings on a steel axis, rigidly fixed to the foundation (4), to said hollow shaft being coaxially fixed belted wheel (38), connected through a belt (37) to a wheel (36), coupled to the output shaft of an electric motor-reducer (35), performing the rotation of the whole device.

2. An advertising device according to claim 1, characterised in that the prismatic body is mounted by means of the foundation (4) on a platform (5) of a lorry.

3. An advertising device according to claim 1 or claim 2, characterised in that to both ends of the axes of rolls (9) are attached springs (10), effecting the parallel movement of rolls (9).

4. An advertising device according to claim 1 or claim 2, characterised in that the observing windows (1.1, 1.2, . . . 1.n) are covered by protective dismountable transparent screens (2).

5. An advertising device according to claim 1 or claim 2, characterised in that the lower and the upper base as well the outside vertical edges of the prismatic body are covered by dismountable resistant to atmospheric influence, lasting sheet material.

6. An advertising device according to claim 1 or claim 2, characterised in that plates (24, 25) are fixed at even distances to the links of chain (11) by means of spot welds.

7. An advertising device according to claim 1 or claim 2, characterised in that behind the visible area of tapes (21) a set of illuminants (39) is mounted.

8. An advertising device according to claim 1 or claim 2, characterised in that lengthwise of the lower set of chains (11) are evenly spaced apart from one another fingers (34)

9. An advertising device according to claim 1 or claim 2, characterised in that under the lower base of the prismatic body closed to the angles are mounted wheels, freely rolling on the platform on which the foundation (4) is mounted.

10. An advertising device according to claim 1 or claim 2, characterised in that the hollow steel profile (28) is fixed to the common supporting frame (6) by means of bolts (29) and nuts (30).
